(19) United States
(12) Patent Application Publication
(10) Pub. No.: US 2010/0024388 A1
(43) Pub. Date: Feb. 4, 2010

(54) Flow-Restricting Filter, Solid Propellant Gas Generator and Propulsion System Comprising the Same

(75) Inventors: Moon Geun HONG, Daejeon-shi (KR); Soo Yong LEE, Seoul (KR)

Correspondence Address: HOLME ROBERTS & OWEN LLP, 1700 LINCOLN STREET, SUITE 4100, DENVER, CO, 80203, US

(73) Assignee: KOREA AEROSPACE RESEARCH INSTITUTE, Daejeon-shi (KR)

(21) Appl. No.: 12/262,774

(22) Filed: Oct. 31, 2008

(30) Foreign Application Priority Data
Nov. 2, 2007 (KR) 10-2007-0111560

(51) Int. Cl. F02K 9/08; B01D 35/157

(52) U.S. Cl. 60/253; 55/419

(57) ABSTRACT

The present invention discloses a flow-restricting filter capable of restricting intentionally the flow of the combustion gas from a solid propellant gas generator to an external member (for example, the nozzle) to rise up combustion pressure resulting in increasing a burning rate of the solid propellant and in reducing a burning area of the solid propellant and the overall size of the gas generator. The flow-restricting filter according to the present invention comprises a hollow member having a plurality of through holes formed thereon; and a flow-blocking plate provided at one end of the hollow member to form a space having one closed end and another opened end in the hollow member.

### CROSS-REFERENCE TO RELATED APPLICATIONS

This application claims priority from Korean Patent Application No. 2007-111560, filed on Nov. 2, 2007, the contents of which are incorporated herein by reference in its entirety.

### BACKGROUND OF THE INVENTION

The present invention relates to a flow-restricting filter, a solid propellant gas generator and a propulsion system comprising the same, more particularly, to a flow-restricting filter acting as a flow restriction device capable of restricting a flow of fluid (for example, combustion gas) between a first member (for example, a combustion chamber of a gas generator) and a second member (for example, a nozzle) to rise up combustion pressure resulting in increasing a burning rate of solid propellant, and a solid propellant gas generator and a propulsion system comprising the same.

In general, a solid propellant gas generator plays a role as a turbo pump starter in liquid propellant propulsion system by supplying pressurized gas to power turbines for engine start.

FIG. 1 is a schematic view illustrating a conventional solid propellant gas generator-turbines system. As shown in FIG. 1, combustion gas produced in a gas generator 10 is supplied to a turbine assembly 40 through a nozzle 20 to drive the turbine assembly 40 for engine start.

FIG. 2 is a detail view showing an inner structure of the solid propellant gas generator 10 shown in FIG. 1. The gas generator 10 comprises a combustion chamber 31, the inside of the combustion chamber 31 is partially filled with a solid propellant 32. The gas generator 10 further comprises an igniter 33 mounted to the combustion chamber 31 in order to ignite the solid propellant 32.

The combustion gas produced in the gas generator 10 flows into the turbine assembly (40 in FIG. 1) through the nozzle 20 mounted to the combustion chamber 31.

In the solid propellant gas generator 10 as described above, the solid propellant 32 shall have relatively low combustion temperature not to cause any degradation of the turbine blades. This low combustion temperature of the solid propellant generally has also cause for a low burning rate.

In order to drive the turbine 40, a certain amount of the combustion gas should be supplied into the turbine assembly 40 through the nozzle 20. However, because of the low burning rate of the solid propellant generally employed in the gas generator, the burning area of the propellant intends to increase to satisfy the required mass flux. Consequently, an increment of the burning area brings on the gas generator size augmentation. This increment of the envelop and the weight of gas generator has negative effects on the design and the performance of a propulsion system.

### SUMMARY OF THE INVENTION

The present invention is conceived to solve the above problems, an objective of the present invention is to provide a flow-restricting filter acting as a flow device capable of restricting a flow of fluid (for example, combustion gas) between a first member (for example, a combustion chamber of a gas generator) and a second member (for example, a nozzle) to rise up combustion pressure resulting in increasing a burning rate of solid propellant in a gas generator.

Another objective of the present invention is to provide a solid propellant gas generator and a propulsion system comprising the above flow-restricting filter.

A flow-restricting filter according to the present invention comprises a hollow member having a plurality of through holes formed thereon; and a flow-blocking plate provided at one end of the hollow member to form a space having one closed end and another opened end in the hollow member.

Here, the through holes are formed on the hollow member at regular intervals and the hollow member can be formed integrally with the flow-blocking plate.

A solid propellant gas generator according to the present invention comprises a combustion chamber in which a propellant is received and combustion gas is generated; and a flow-restricting filter mounted to an outlet portion of the combustion chamber. Here, the flow-restricting filter comprises a hollow member provided at an outlet portion of the combustion chamber of the solid propellant gas generator and having a plurality of through holes formed thereon; and a flow-blocking plate provided at an inlet end of the hollow member to form a space having a closed inlet end and an opened outlet end in the hollow member. A flow of a combustion gas produced in the combustion chamber is obstructed by the flow-blocking plate, flows in the space in the hollow member through the through holes of the flow-restricting filter and then discharged to an external device.

A propulsion system of the present invention comprises a solid propellant gas generator including a combustion chamber in which a solid propellant is received and combustion gas is produced; a flow-restricting filter mounted to an outlet portion of the combustion chamber, a nozzle part coupled to the opened outlet end of the flow-restricting filter; and a turbine assembly connected to the combustion chamber of the gas generator and operated by the combustion gas passing through the nozzle.

Here, the flow-restricting filter constituting the propulsion system comprises a hollow member provided at an outlet portion of the combustion chamber and having a plurality of through holes formed thereon; and a flow-blocking plate provided at an inlet end of the hollow member to form a space having a closed inlet end and an opened outlet end in the hollow member. A flow of a combustion gas produced in the combustion chamber is obstructed by the flow-blocking plate, flows in the space in the hollow member through the through holes of the flow-restricting filter and then passes through the nozzle part.

### BRIEF DESCRIPTION OF THE DRAWINGS

The above and other features and advantages of the present invention will become readily apparent by reference to the following detailed description when considered in conjunction with the accompanying drawings wherein;

FIG. 1 is a general schematic view illustrating a conventional solid propellant gas generator-turbines system;

FIG. 2 is a detail view of a gas generator shown in FIG. 1;

FIG. 3 is a sectional view of a solid propellant gas generator to which a flow-restricting filter of the present invention is mounted;

FIG. 4A is a perspective view of a flow-restricting filter of the present invention; and

FIG. 4B is a partially sectional perspective view of a flow-restricting filter and a nozzle.

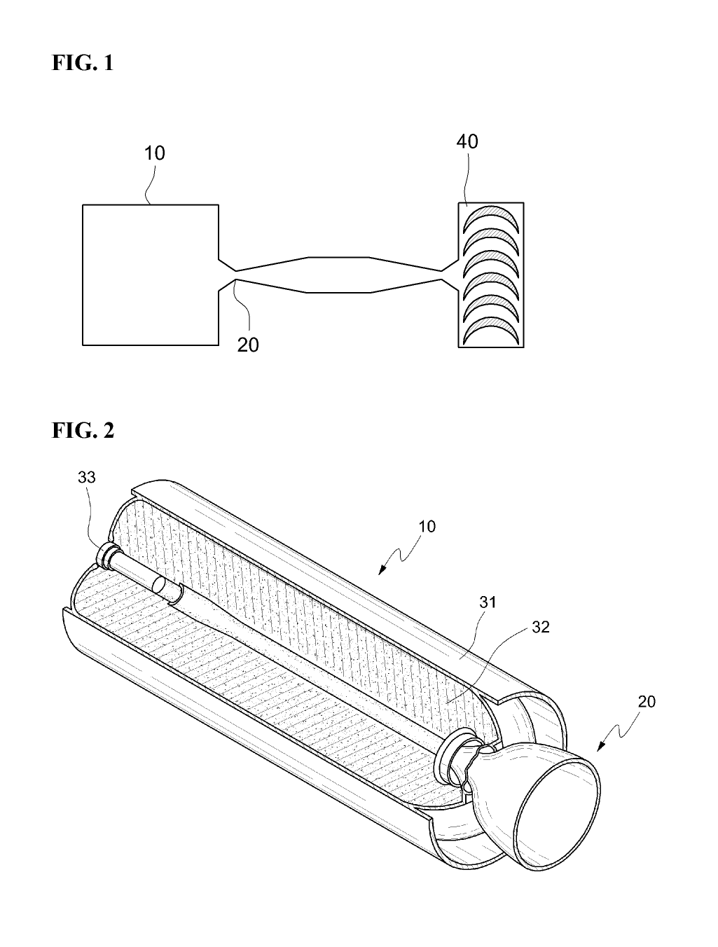

### DESCRIPTION OF SPECIFIC EMBODIMENTS

Hereinafter, the preferred embodiments of the present invention will be explained in more detail with reference to the accompanying drawings.

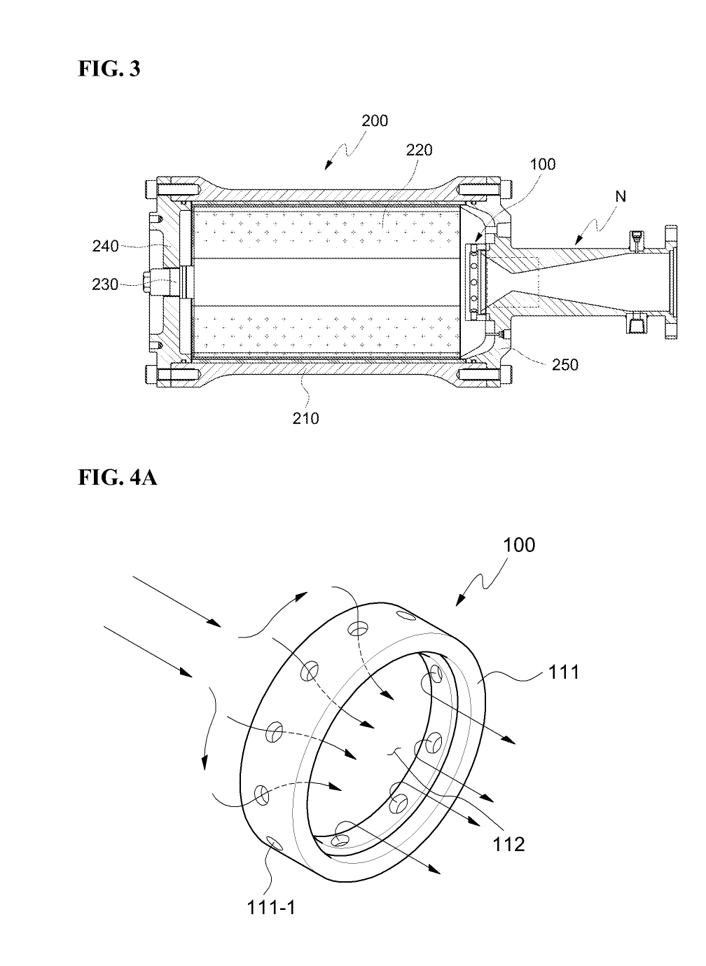

FIG. 3 is a sectional view of a solid propellant gas generator to which a flow-restricting filter of the present invention is mounted.

As shown in FIG. 3, a flow-restricting filter 100 according to the present invention is installed in a solid propellant gas generator (hereinafter, referred to as “gas generator”) 200, a combustion chamber 210 of the gas generator 200 is partially filled with a solid propellant 220.

In such gas generator 200, a front cover 240 is installed on a front portion of the combustion chamber 210 and a rear cover 250 is mounted on a rear portion (outlet portion) of the combustion chamber 210, and so the combustion chamber 210 has a sealed space formed therein.

In addition, an igniter 230 is mounted to the front cover 240 of the combustion chamber 210 for the ignition of the solid propellant 220.

The flow-restricting filter 100 according to the present invention is installed at an outlet portion (i.e., the rear cover 250) of the gas generator 200 constructed as above. While combustion gas passes through the flow-restricting filter 100, the pressure of combustion chamber is increased by the pressure loss effect of the flow-restricting filter 100, and the increment of pressure in the combustion chamber 210 brings on the augmentation of the burning rate of the solid propellant 220. Then, the combustion gas produced with this increased burning rate flows into a nozzle part N connected with a turbine system (not shown).

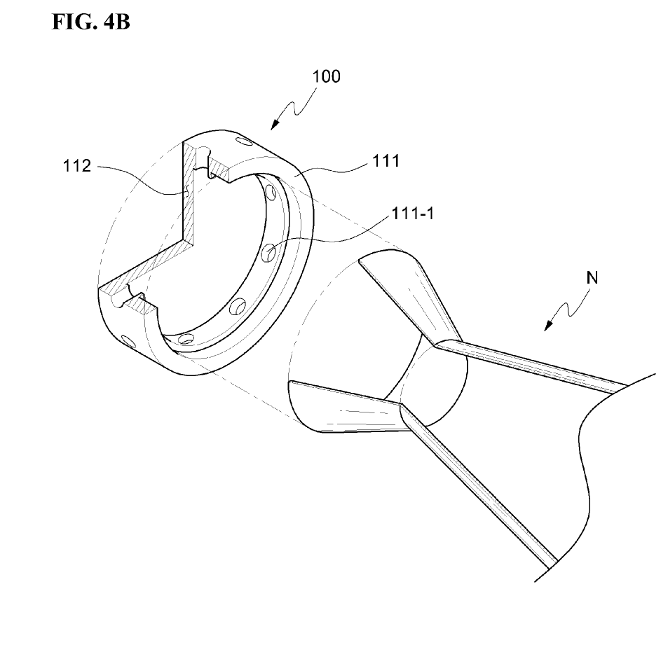

Below, the flow-restricting filter 100 is illustrated with reference to FIG. 3, FIG. 4A and FIG. 4B.

FIG. 4A is a perspective view of the flow-restricting filter of the present invention, and FIG. 4B is a partially sectional perspective view of the flow-restricting filter and the nozzle part.

The flow-restricting filter 100 is a kind of flow restriction device to obstruct a flow of fluid (for example, combustion gas in the gas generator 200) to increase the pressure of the combustion chamber 210 and the burning rate of the propellant 220. The flow-restricting filter 100 comprises a hollow member 111 having an inlet end corresponding to an inside of the gas generator 200 and an outlet end corresponding to the nozzle part N.

The flow-restricting filter 100 further comprises a flow-blocking plate 112 fixed to an inlet end of the hollow member 111. Due to the flow-blocking plate 112, a space having one opened end and one closed end is formed in the hollow member 111. At time, the hollow member 111 may be formed integrally with the flow-blocking plate 112.

A plurality of through holes 111-1 are formed on the hollow member 111, and so an inner space of the gas generator 200 and the nozzle part N are communicated with each other via the through holes 111-1 of the flow-restricting filter 100 for a passage of the combustion gas.

As shown in FIG. 3, the flow-restricting filter 100 having the structure as described is mounted to a gas exhausting portion of the gas generator 200, and the nozzle part N is connected to the gas exhausting portion of the gas generator 200. Accordingly, the combustion gas produced in the gas generator 200 flows to the nozzle part N via the flow-restricting filter 100.

As shown in FIG. 4A, while the combustion gas (indicated by the arrow) produced in the gas generator 200 passes through the flow-restricting filter 100, the combustion gas is obstructed by the flow-blocking plate 112 of the flow-restricting filter 100.

The combustion gas obstructed by the flow-blocking plate 112 of the flow-restricting filter 100 flows around the hollow member 111 and then introduced into the inner space of the hollow member 111 of the flow-restricting filter 100 through the through holes 111-1. The combustion gas in the hollow member 111 of the flow-restricting filter 100 passes through the nozzle part N, and then flows into the turbine assembly (40 in FIG. 3).

In the above process, the flow-restricting filter 100 brings on the increment of the pressure in the combustion chamber 210 of the gas generator 200 and consequently the increment of the burning rate of the propellant 220. The increased burning rate of the propellant 220 allows the reduction of the burning area of the propellant 220 for the required mass flux.

For the application of gas generators in which solid propellants with a low burning rate are employed, the considerable reduction of the size and the weight of gas generator is achievable just by installing the flow-restricting filter 100 according to the present invention.

In the meantime, it is preferable that a plurality of through holes 111-1 are formed on the hollow member 111 of the flow-restricting filter 100 at regular intervals to supply the combustion gas into the space of the hollow member 111.

Here, as shown in FIG. 3 and FIG. 4, an end portion (inlet portion) of the nozzle part N may be placed in the opened end portion of the hollow member 111 of the flow-restricting filter 100, and so the combustion gas exhausted from the flow-restricting filter 100 flows into the nozzle part N without any leakage and then passes to the turbine system (40 in FIG. 4). At this time, it will be apparent that the end portion of the nozzle N placed in the hollow member 111 does not correspond to the through holes 111-1 of the flow-restricting filter 100.

As described above, the flow-restricting filter 100 according to the present invention restricts intentionally a flow of the combustion gas from the gas generator to the external member (for example, the nozzle part) to rise up combustion pressure in the combustion chamber of the gas generator resulting in increasing solid propellant burning rate and in reducing the propellant burning area and the overall size of the gas generator.

In the meantime, in a case where the gas generator 200 comprising the flow-restricting filter 100 according to the present invention is employed for the propulsion system, since a burning area of the solid propellant can be smaller by the increase of the burning rate of the solid propellant in addition to the change of the nozzle throat area, there is considerable reduction of the dimension and the weight of gas generator, and so reduction of the dimension and the weight of propulsion system can be achieved.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A flow-restricting filter, comprising;
a hollow member having a plurality of through holes formed thereon; and
a flow-blocking plate provided at one end of the hollow member to form a space having one closed end and another opened end in the hollow member.

2. The flow-restricting filter of claim 1, wherein the through holes are formed on the hollow member at regular intervals.

3. The flow-restricting filter of claim 1, wherein the hollow member is formed integrally with the flow-blocking plate.

4. A solid propellant gas generator, comprising;
a combustion chamber in which a solid propellant is received and a combustion gas is generated; and
a flow-restricting filter mounted to an outlet portion of the combustion chamber, the flow-restricting filter comprising a hollow member provided at the outlet portion of the combustion chamber and having a plurality of through holes formed thereon; and a flow-blocking plate provided at an inlet end of the hollow member to form a space having a closed inlet end and an opened outlet end in the hollow member,
wherein a flow of the combustion gas produced in the combustion chamber is obstructed by the flow-blocking plate, flows in the space in the hollow member through the through holes of the flow-restricting filter and then discharged to an external device.

5. The solid propellant gas generator of claim 4, wherein the through holes are formed on the hollow member of the flow-restricting filter at regular intervals.

6. A propulsion system, comprising;
a solid propellant gas generator including a combustion chamber in which a solid propellant is received and combustion gas is produced;
a flow-restricting filter mounted to an outlet portion of the combustion chamber, the flow-restricting filter comprising a hollow member provided at the outlet portion of the combustion chamber and having a plurality of through holes formed thereon; and a flow-blocking plate provided at an inlet end of the hollow member to form a space having a closed inlet end and an opened outlet end in the hollow member,
a nozzle part coupled to the opened outlet end of the flow-restricting filter; and
a turbine assembly connected to the combustion chamber of the solid propellant gas generator and operated by a combustion gas passing through the nozzle part,
wherein a flow of the combustion gas produced in the combustion chamber of the solid propellant gas generator is obstructed by the flow-blocking plate, flows in the space in the hollow member through the through holes of the flow-restricting filter and then passes through the nozzle part.

7. The propulsion system of claim 6, wherein the through holes are formed on the hollow member of the flow-restricting filter at regular intervals.

8. The propulsion system of claim 6, wherein the inlet end of the nozzle is placed in the opened outlet end of the hollow member of the flow-restricting filter.
